(19) United States
(12) Patent Application Publication
(10) Pub. No.: US 2025/0225958 A1
(43) Pub. Date: Jul. 10, 2025

(54) DIGITAL IMAGE DISPLAY DEVICE, OPERATION METHOD THEREOF, AND ELECTRONIC SYSTEM

(71) Applicant: SAMSUNG ELECTRONICS CO., LTD., Suwon-si (KR)

(72) Inventor: Jungkyu Kook, Suwon-si (KR)

(21) Appl. No.: 18/800,522

(22) Filed: Aug. 12, 2024

(30) Foreign Application Priority Data
Jan. 9, 2024 (KR) 10-2024-0003489

(51) Int. Cl. G09G 5/393

(52) U.S. Cl. CPC G09G 5/393; G09G 2370/042

(57) ABSTRACT

A display device includes a receiver configured to receive a first request signal requesting first performance information, as performance information of the display device, from the outside, a memory configured to store second performance information which contains a first data block containing first data as a header consisting of a fixed pattern indicating that it is first performance information and a second data block containing second data as block tags for identifying data blocks, and a controller configured to output data having a predetermined size from the first data, as the first performance information, to the receiver, based on the first request signal, such that the receiver outputs the first performance information to the outside.

### CROSS-REFERENCE TO RELATED APPLICATION

This application claims priority to and the benefit of Korean Patent Application No. 10-2024-0003489 filed in the Korean Intellectual Property Office on Jan. 9, 2024, the entire content of which is incorporated herein by reference.

### BACKGROUND

Display devices can display images based on inputs from various source devices connected to the display devices. For example, a display device can display images stored in the display device and receive images from a source device connected thereto through a cable such as a high-definition multimedia interface (HDMI) and display them.

In recent years, digital image display devices capable of high-definition image display have become more widely available and contents with the resolution of Ultra HD beyond the resolution of Full HD (High Definition) have increased, and source devices may process the formats of contents according to the performance information of display devices, and provide the processed contents to the display devices.

### SUMMARY

The present disclosure relates to a display device containing various versions of performance information, an operation method of the display device, and an electronic system.

Also, the present disclosure relates to a display device, an operation method of the display device, and an electronic system capable of improving the compatibility between a source device and the display device.

Further, the present disclosure relates to a display device, an operation method of the display device, and an electronic system capable of providing the performance information of the display device to a source device.

A display device according to some implementations may include a receiver configured to receive a first request signal requesting first performance information, as performance information of the display device, from the outside, a memory configured to store second performance information which contains a first data block containing first data as a header consisting of a fixed pattern indicating that it is first performance information and a second data block containing second data as block tags for identifying data blocks, and a controller configured to output data having a predetermined size from the first data, as the first performance information, to the receiver, based on the first request signal, such that the receiver outputs the first performance information to the outside.

An operation method of a display device according to some implementations may include receiving a first request signal requesting first performance information of the display device, reading the first performance information from second performance information containing the first performance information, based on the first request signal, reading data of second information of the second performance information as data of first information of the first performance information, and outputting the first performance information.

An electronic system according to some implementations may include a first source device configured to output a first request signal requesting first performance information as performance information of a display device, a second source device configured to output a second request signal requesting second performance information as performance information of a display device, and a display device configured to output some of the second performance information as the first performance information to the first source device based on the first request signal, and output the second performance information to the second source device based on the second request signal.

### BRIEF DESCRIPTION OF THE DRAWINGS

FIG. 1 is a configuration diagram of an electronic system according to some implementations.

FIG. 2 is a block diagram of a source device and a display device according to some implementations.

FIG. 3 is a drawing illustrating an extended display identification data (EDID) structure.

FIG. 4 is a drawing illustrating data blocks of Display Identification Data (DisplayID).

FIG. 5 is a drawing for explaining the structure of a data block of DisplayID.

FIG. 6 is a drawing for explaining the structure of a data block of DisplayID.

FIG. 7 is a drawing illustrating a DisplayID structure according to some implementations.

FIG. 8 is a drawing illustrating display product identification information of EDID.

FIG. 9 is a drawing illustrating mapping information defining the relationship between DisplayID and EDID according to some implementations.

FIG. 10 is a drawing for explaining how a display device provides EDID based on mapping information according to some implementations.

FIG. 11 is a drawing for explaining display parameter information of EDID.

FIG. 12 is a drawing illustrating mapping information defining the relationship between DisplayID and EDID according to some implementations.

FIG. 13 is a drawing for explaining how a display device provides EDID based on mapping information according to some implementations.

FIG. 14 is a drawing for explaining a display system according to some implementations.

### DETAILED DESCRIPTION

In the following detailed description, only certain implementations of the present invention have been shown and described, simply by way of illustration. As those skilled in the art would realize the described implementations may be modified in various different ways without departing from the spirit or scope of the present invention.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. The terms are used only to discriminate a constituent element from other constituent elements.

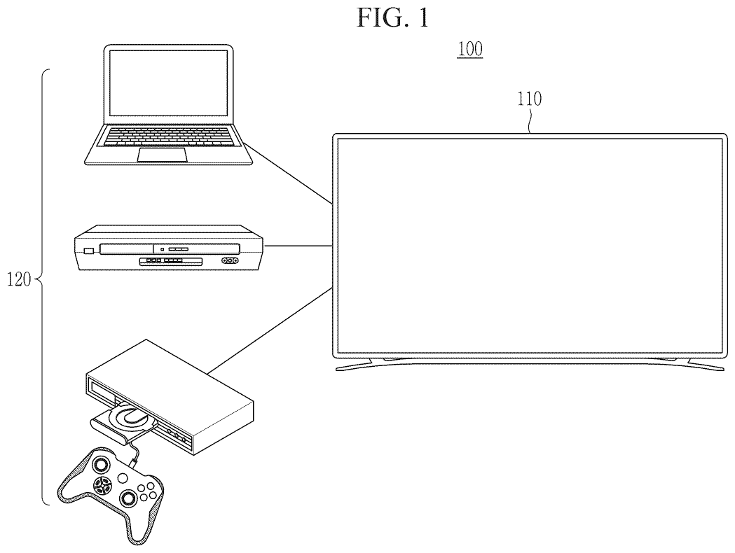

FIG. 1 is a configuration diagram of an electronic system according to some implementations.

According to FIG. 1, an electronic system 100 includes a display device 110 and a source device 120.

The source device 120 may provide content, such as video, audio, and the like, to the display device 110. For example, the source device 120 may include various types of electronic devices capable of providing contents to the display device 110, such as a set-top box, an over-the-top (OTT) device, a Digital Versatile Disc (DVD) player, a Blu-ray disc player, a personal computer (PC), a game machine, and the like.

The display device 110 may output or display contents which are received from the source device 120. For example, the display device 110 may include various types of electronic devices capable of receiving contents and outputting the contents, such as a network TV, a smart TV, an Internet TV, a web TV, an Internet Protocol TV (IPTV), a PC, and the like. Since the display device 110 is able to receive and display contents, it may be referred to as a content receiving device, a computing device, or the like. A plurality of source devices can be connected to a display device 110.

The display device 110 and the source device 120 may be connected through various connection means and may transmit and receive contents. The various connection means may include a cable, and the display device 110 and the source device 120 may include one or more ports for cable connection. The one or more ports may include a digital input interface such as a High-Definition Multimedia Interface (HDMI) port, a display port, a Type-C port, or the like. For example, the display device 110 and the source device 120 may each have an HDMI port and perform communication through the corresponding port.

The video electronics standards association (VESA) established a DisplayID (identification data) standard and an extended display identification data (EDID) standard related to performance information on the display device 110, and a display data channel (DDC) protocol for data communication between the source device 120 and the display device 110. According to the DDC protocol, when the display device 110 is connected to the source device 120 and power is applied to the display device 110, the display device 110 may provide DisplayID or EDID to the source device 120. Further, when the source device 120 receives the DisplayID or the EDID from the display device 110, the source device may provide contents corresponding to the DisplayID or the EDID such that the display device 110 can display images. The display device 110 may store at least one of the DisplayID and the EDID.

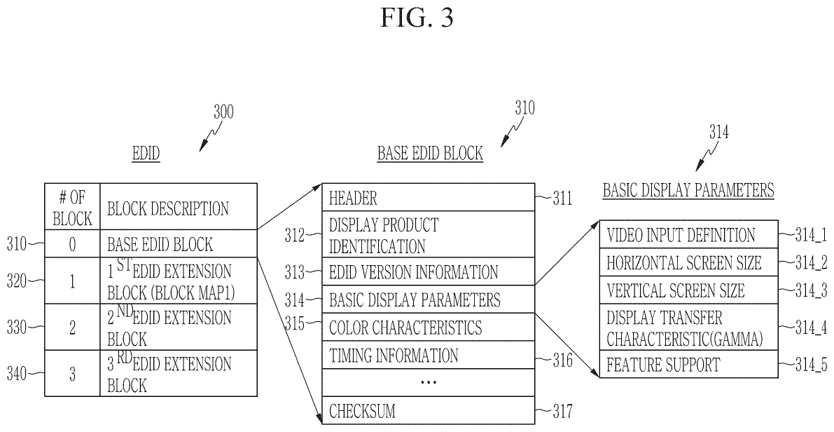

The DisplayID and the EDID define data formats for enabling the source device 120 to read the display performance of the display device 110. For example, the DisplayID and the EDID may contain screen ratio information, and information on the manufacturer name, the month and year of product manufacture, the product type, the DisplayID and EDID versions, the resolution and color coordinates of the product, phosphor and filter types, timings, the screen size, luminance, pixels, and the like. The DisplayID is a VESA standard intended to replace the EDID, and for example, while the EDID contains low-resolution (for example, HD or Full HD) information since the EDID does not have enough bits to contain high-resolution information such as 4K or 8K ultra high definition (UHD)), the DisplayID can contain high-resolution information such as 4K or 8K UHD. A detailed description of the DisplayID and the EDID will be made below with reference to FIGS. 3 to 6.

As described above, the DisplayID further contains performance information with respect to specific functions (for example, resolution and the like), as compared to the EDID. Also, the display device 110 including the DisplayID may provide performance according to the DisplayID, and the source device 120 connected thereto may be forced to read the performance information stored by the display device 110. However, when the performance information stored by the display device 110 and the performance information that the source device 120 can read are different from each other, for example, when the display device 110 stores the DisplayID as performance information and the source device 120 can read only the EDID as the performance information of the display device 110, there is a problem that the source device 120 cannot read the performance information from the display device 110.

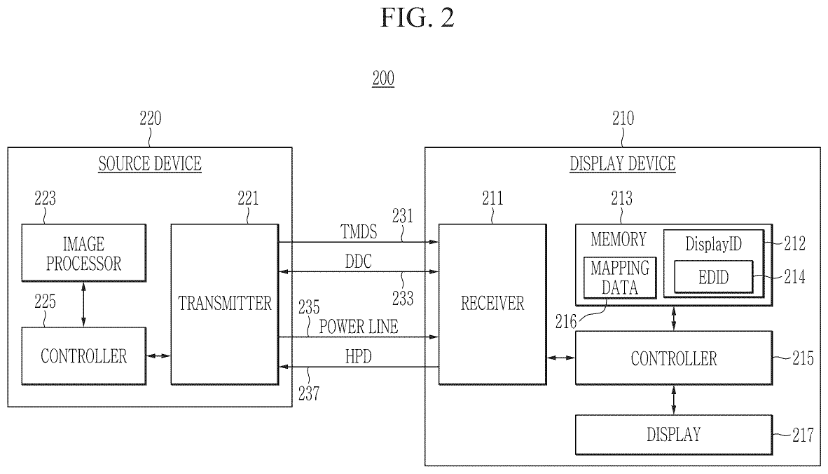

FIG. 2 is a block diagram of a source device and a display device according to some implementations.

In some implementations, an electronic device 200 includes a source device 220 and a display device 210.

In some implementations, the source device 220 includes a transmitter 221, an image processor 223, and a controller 225.

In some implementations, the transmitter 221 may output video signals, audio signals, and the like with resolution that the display device 210 can process. Also, the transmitter 221 may receive DisplayID or EDID containing display performance information including information on supportable resolution from the display device 210. In some implementations, the source device 220 may read only EDID 214 as the performance information of the display device 210. When the source device 220 can read only the EDID 214 of the display device 210 according to some implementations, the transmitter 221 may receive the value of specific information of DisplayID 212 as the value of specific information of the EDID 214 from the display device 210.

In some implementations, the image processor 223 may process images to be transmitted through the transmitter 221 under the control of the controller 225. The controller 225 may control the overall operation of the source device 220. For example, the controller 225 may control the image processor 223 such that the image processor processes video signals, audio signals, and the like to be transmitted to the display device 210, and may perform control such that the video signals, the audio signals, and the like processed are output through the transmitter 221.

In some implementations, the display device 210 includes a receiver 211, a memory 213, a controller 215, and a display 217.

In some implementations, the receiver 211 may receive video signals, audio signals, and the like from the source device 220 according to a connected protocol and output them to the display 217, under the control of the controller 215. In some implementations, the receiver 211 may receive, from the transmitter 221, a request signal requesting the performance information, and output the EDID 214 or the DisplayID 212 as the performance information of the display device 210 to the transmitter 221.

In some implementations, the display 217 may display the video signals and the like, received from the controller 215, on the screen.

In some implementations, the memory 213 may contain the DisplayID 212 and the EDID 214 as the performance information of the display device 210. In some implementations, the EDID 214 may be stored in some area within the DisplayID 212, or may be stored in some data blocks of a plurality of data blocks of the DisplayID 212. In some implementations, the memory 213 may store the EDID 214 in a form in which the specific information of the EDID 214 is mapped onto the specific information of the DisplayID 212. Alternatively, the memory 213 may store a command instructing the controller 215 to read the specific information of the DisplayID 212 as the EDID (214) information.

In some implementations, the controller 215 may control the overall operation of the display device 210. When the receiver 211 receives a signal from the source device 220 requesting the EDID, the controller 215 may control the receiver 211 such that the receiver 211 transmits the EDID 214, stored in the memory 213, to the source device 220. In some implementations, when the receiver 211 receives a signal requesting the EDID from the source device 220, the controller 215 may sequentially read the EDID 214 stored in the memory 213 and read the value of the specific information of the DisplayID 212 as the value of the specific information of the EDID 214. Specifically, the controller 215 may read the specific information of the DisplayID 212 as the EDID (214) information, on the basis of the EDID 214 stored in the memory 213 in the form in which the specific information of the EDID 214 is mapped onto the specific information of the DisplayID 212. Alternatively, the controller 215 may read the specific information of the DisplayID 212 as the EDID (214) information, on the basis of the command instructing to read the specific information of the DisplayID 212 as the EDID (214) information, stored in the memory 213.

In some implementations, the memory 213 may further contain mapping information (e.g., mapping data) 216. The mapping information 216 may contain information for mapping the specific information of the EDID 214 onto the specific information of the DisplayID 212. Specifically, the mapping information 216 may contain the information of the EDID 214 to be the subject of mapping, and the information of the DisplayID 212 to be mapped as data corresponding to the information of the EDID.

In some implementations, when the receiver 211 receives a signal requesting the EDID from the source device 220, the controller 215 may read the EDID 214 stored in the memory 213 and identify the information of the EDID 214 that is the subject of mapping, on the basis of the mapping information 216. The controller 215 may read the data of the information of the DisplayID 212 as the data corresponding to the information of the EDID 214 that is the subject of mapping based on the mapping information 216, and control the receiver 211 such that the receiver transmits the read data as the data of the EDID 214 to the source device 220.

In some implementations, when the receiver 211 receives a signal requesting the DisplayID from the source device 220, the controller 215 may control the receiver 211 such that the receiver transmits the DisplayID 212, stored in the memory 213, to the source device 220.

The display device 210 according to some implementations has an advantage of being able to maintain the size of the performance information, which is stored in the display device 210, at the DisplayID size (for example, 128 bytes) by storing the EDID 214 in some area within the DisplayID 212 and mapping the specific information of the EDID 214 onto the specific information of the DisplayID 212. In some implementations, the memory 213 may be implemented as an electrically erasable programmable read-only memory (EEPROM).

In some implementations, the transmitter 221 of the source device 220 and the receiver 211 of the display device 210 may be connected through one or more cables. Hereinafter, it is assumed that the transmitter 221 and the receiver 211 are connected through an HDMI cable, and a communication process in this case will be described.

In some implementations, the HDMI cable includes a transition minimized differential signaling (TMDS) line 231 for transferring audio and video signals and the like, a DDC line 233 for transferring the DisplayID or EDID information, a power supply line 235, and a hot plug detect (HPD) line 237 for controlling reading of the DisplayID or the EDID.

In some implementations, data communication between the source device 220 and the display device 210 follow a DDC protocol. According to the DDC protocol, the source device 220 and the display device 210 may be connected by the HDMI cable, and the transmitter 221 of the source device 220 may provide a preset voltage, for example, a voltage of 5 V, to the receiver 211 of the display device 210 through the power supply line 235. When the receiver 211 receives the preset voltage, it may transmit a high-level signal to the transmitter 221 through the HPD line 237. When the transmitter 221 receives the high-level signal from the receiver 211 through the HPD line 237, the transmitter 221 may transmit a request signal requesting the DisplayID or the EDID, i.e., the performance information of the display device 210 through the DDC line 233, and when the receiver 211 receives the request signal, it may provide the performance information of the display device 210 to the transmitter 221.

Here, the DDC protocol supports bidirectional communication between the source device 220 and the display device 210, using a high-speed synchronous serial communication system referred to as an inter-integrated circuit (I2C). Accordingly, the source device 220 and the display device 210 may be divided into a master and a slave and exchange data or signals. In other words, the source device 220 may transmit a signal requesting the DisplayID or EDID of the display device 210, as a master, and the display device 210 may receive the signal from the source device 220, as a slave. Meanwhile, according to the DDC protocol standard, the DisplayID and EDID in the display device 210 may use slave addresses different from each other. Specifically, from the display device 210 including the DisplayID and the EDID, the source device 220 may read the EDID information, using a first slave address (e.g., a slave address A0h and A1h), and read the DisplayID information, using a second slave address (e.g., a slave address A4h and A5h).

According to some implementations, the display device 210 may output the EDID 214 or the DisplayID 212, stored in the display device 210, according to the performance information which the source device 220 can read. According to some implementations, since the display device 210 stores the DisplayID 212 and the EDID 214 together, there is an advantage of improving the compatibility of the source device 220 and the display device 210. Hereinafter, the EDID and the DisplayID will be described. However, information or values related to EDID and DisplayID to be described below are intended for convenience of explanation and understanding, and the information or values of the EDID and the DisplayID are not limited to the following description and the drawings.

FIG. 3 is a drawing illustrating an EDID structure.

The extended display identification data (EDID) are a standardized means for the display device (e.g., reference symbol “210” in FIG. 2) to communicate its own display performance information to the source device (e.g., reference symbol “220” in FIG. 2). The display device 210 may transmit the performance information, such as the default resolution and the recommended resolution, to the source device 220 connected thereto through the EDID, and the source device 220 may generate a format of content required to meet a request of the display device 210, on the basis of the EDID.

EDID 300 may include one or more data blocks to have an extendable form of structure such that it is possible to contain information according to an increase in the specification of the display device 210. For example, the EDID 300 may include one base EDID block and one or more extended EDID blocks. Referring to FIG. 3, the EDID 300 includes four blocks, a base EDID block 310, a first extended EDID block 320, a second extended EDID block 330, and a third extended EDID block 340. The base EDID block 310 which is the first block is an essential block and may have, for example, a version of EDID 1.3 or higher. The base EDID block 310 may be referred to as a VESA block. The first extended EDID block 320 which is the second block may refer to an extended block or a block map. For example, when the EDID 300 includes a total of two blocks, the first extended EDID block 320 may become an extended block, and when the EDID 300 includes three or more blocks, the first extended EDID block 320 may refer to a block map containing information on the extended blocks.

The base EDID block 310 may contain various information indicative of the characteristic information of the display device 210. The size of the base EDID block 310 may be fixed to a predetermined size (for example, 128 bytes). The base EDID block 310 includes a header 311 consisting of a fixed pattern indicating that it's an EDID file, display product identification information 312 containing product information such as the display manufacturer, the manufacture date, and the like, EDID version information 313, basic display parameters 314 defining the characteristics of the display device, color characteristics 315 defining a RGB color space conversion technique which is used in the display device, detailed timing information 316 of resolutions which are supported by the display device, a checksum 317, etc. For example, the basic display parameters 314 may define whether the display device has received any analog or digital input or not (e.g., reference symbol “314_1”), the maximum horizontal size and vertical size of the display (e.g., reference symbols “314_2” and “314_3”), a gamma transfer characteristic (e.g., reference symbol “314_4”), a power management function (e.g., reference symbol “314_5”), etc.

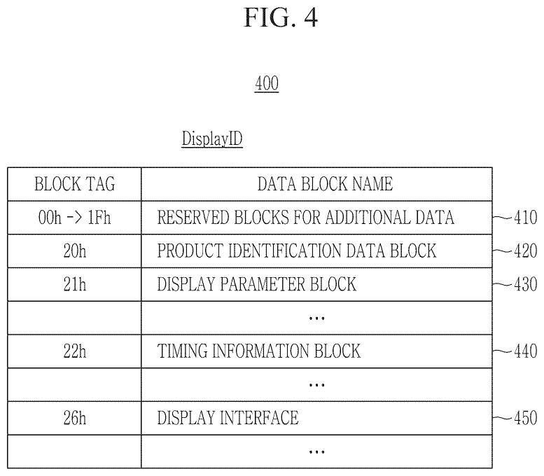

In some implementations, the EDID 300 may be stored in some area within the DisplayID. In some implementations, some area within the DisplayID may refer to a data block within the DisplayID. In some implementations, the specific information (for example, the display product identification information 312, the basic display parameters 314, and the like) of the EDID 300 may be identical to the specific information within the DisplayID. Accordingly, the memory 213 of the display device 210 according to some implementations may store the EDID 214 in a form in which the specific information of the EDID 214 is mapped onto the specific information of the DisplayID 212, or may store a command instructing the controller 215 to read the specific information of the DisplayID 212 as the EDID (214) information. The controller 215 according to some implementations may read the specific information of the DisplayID 212 as the EDID (214) information, on the basis of the command stored in the memory 213. Alternatively, the mapping information (e.g., reference symbol “216” in FIG. 2) of the display device 210 according to some implementations may map the specific information of the EDID 300 onto the specific information within the DisplayID, and define the information of the DisplayID as the information of the EDID. A detailed description of the DisplayID will be described below with reference to FIGS. 4 to 6.

FIG. 4 is a drawing illustrating data blocks of DisplayID. Specifically, FIG. 4 shows data blocks of DisplayID and block tags of the corresponding blocks.

DisplayID 400 is a VESA standard intended to replace an EDID standard, and version 1.1 of DisplayID was issued in March 2009, version 1.3 thereof was issued in September 2013, and version 2.0 thereof was issued in September 2017. The version of the DisplayID described herein may be DisplayID 2.0, but is not limited thereto. The DisplayID 400 may contain the product name, and the performance information related to the display device 210, such as color regions, support functions, support resolutions, and the like, like the EDID (e.g., reference symbol “300” in FIG. 3). The display device 210 may transmit the DisplayID 400 as performance information to the source device 220 connected thereto, and the source device 220 may generate a format of content required to meet a request of the display device 210, on the basis of the DisplayID 400. Meanwhile, the difference between the DisplayID 400 and the EDID 300 is that the DisplayID 400 uses independently defined modular structures to provide the specific information, with reference to the data block concept.

Referring to FIG. 4, the data blocks of the DisplayID 400 include a display product identification information block 420 containing product information such as the display manufacturer, the manufacture data, and the like, a display parameter block 430 defining the characteristics of the display device, a detailed timing information block 440 which can be supported by the display device, a display interface 450, and the like, each defined independently. The data blocks of the DisplayID may further include a reserved block 410 for additional data. The reserved block 410 may be a data block for storing the performance information of the display device 210 additionally required, according to the source device 220 that is connected to the display device 210. Meanwhile, the DisplayID 400 may include more data blocks containing performance information related to the display device 210.

The data blocks of the DisplayID 400 may include block tags unique to the data blocks. The controller 215 of the display device 210 may identify a data block on the basis of its block tag and read information from the corresponding data block. For example, the controller 215 may identify the corresponding data block as the display product identification information block 420 containing the display product information, on the basis of a block tag ‘20h’, and read information from the corresponding data block.

In some implementations, the reserved block 410 may contain the EDID. In some implementations, the source device 220 capable of reading only the EDID may request the EDID as performance information from the display device 210, and read the EDID, stored in the display device 210, using the first slave address. In response to the request of the source device 220, the controller 215 may read the EDID in the reserved block 410. The display device 210 according to some implementations may map the value of the specific information of the EDID information, identical to the DisplayID information, onto a corresponding data block of the DisplayID, using the mapping information, without describing it in the reserved block 410. Alternatively, the display device 210 according to some implementations may store the EDID in a form in which the specific information of the EDID is mapped onto the specific information of the DisplayID, without describing the value of the specific information of the EDID information, identical to the DisplayID information, in the reserved block 410, or may store a command instructing to read the specific information of the DisplayID as EDID information in the memory. Hereinafter, the display product identification information block 420 and the display parameter block 430 among the data blocks will be described to describe the structures of the data blocks of the DisplayID in detail.

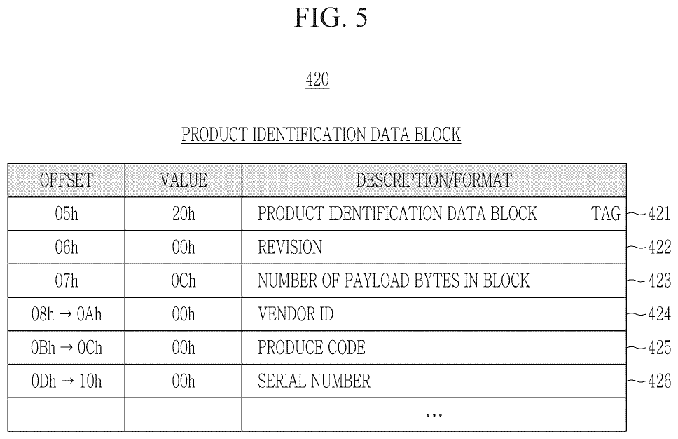

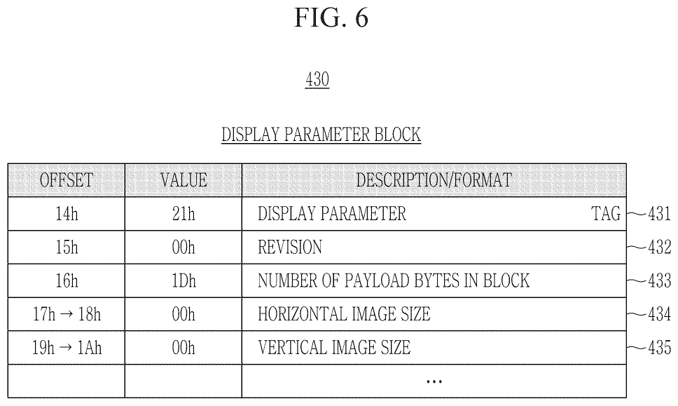

FIGS. 5 and 6 are drawings for explaining the structures of the data blocks of the DisplayID. Specifically, FIG. 5 is a drawing illustrating the display product identification information block of the DisplayID, and FIG. 6 is a drawing illustrating the display parameter block of the DisplayID defining the characteristics of the display device.

The data blocks of the DisplayID (e.g., reference symbol “400” in FIG. 4) may include various fields. The size of each field in the data blocks of the DisplayID 400 is variable, and a specific number of bytes is not designated; however, the size of a specific field may be fixed. The values of individual information items shown in FIGS. 5 and 6 are exemplary and are not limited thereto.

Referring to FIG. 5, the display product identification information block 420 may contain a block tag 421 for the display product identification information block, revision information 422, a vendor ID 424, and the like. The first field is a field for identifying which data block the corresponding data block is, and indicates the tag 421 of the corresponding data block. In other words, as illustrated in FIG. 5, the block tag of the display product identification information block may be ‘20h’ (an offset field may be ‘05h’). Accordingly, the controller 215 of the display device 210 can identify the corresponding data block as the display product identification information block, on the basis of the block tag ‘20h’. The second field indicates a block revision number ‘00h’ of the corresponding data block (see the reference symbol “422”), and the corresponding data may increase when bits are added to the block or bits are changed. The third field indicates the number of payloads (e.g., reference symbol “423”), i.e., ‘0Ch’, used in the corresponding data block, and the other fields may contain the vendor ID 424, a produce code 425, a serial number 426, and the like of the display device, as performance information of the display device 210 that is defined in the display product identification information block.

Referring to FIG. 6, the display parameter block 430 may contain the overall parameters of the display device 210. As illustrated in the drawing, the display parameter block 430 may include a block tag ‘21h’ for the display parameter block (see the reference symbol “431”), the revision number ‘00h’ of the display parameter block (see the reference symbol “432”), and the number of payloads of the display parameter block, i.e., ‘1Dh’ (see the reference symbol “433”), and may include the horizontal and vertical sizes of images (see the reference symbols “434” and “435”) and the like as performance information of the display device which are defined in the corresponding data block.

In some implementations, specific information of the data blocks of the DisplayID may be identical to specific information of the EDID, and the display device according to some implementations may map the specific information of the EDID onto the corresponding information of the DisplayID, using the mapping information. Hereinafter, the structure of the DisplayID containing the EDID, and an operation method of the source device which reads the EDID on the basis of the mapping information will be described.

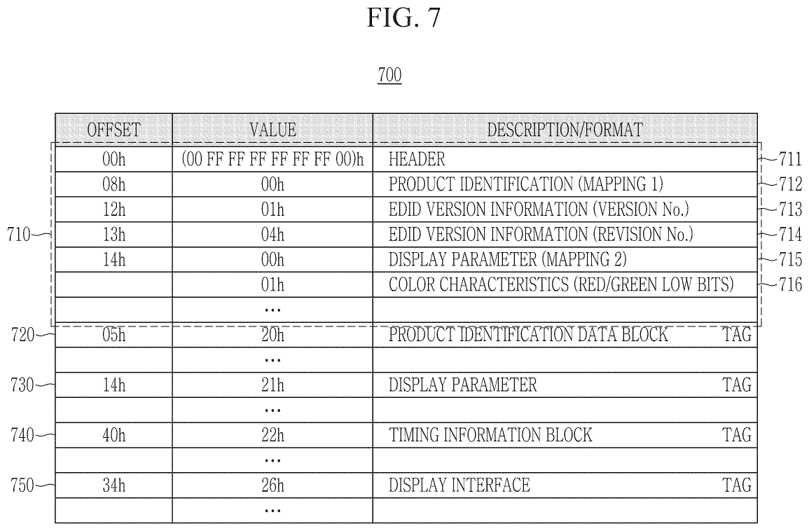

FIG. 7 is a drawing illustrating a DisplayID structure according to some implementations. Specifically, a reserved block 710 of the data blocks of the DisplayID may contain the EDID. A source device according to some implementations may request the EDID as performance information related to the display device 210, and the source device may read the EDID of the display device, using the first slave address. A source device according to some other implementations may request the DisplayID as performance information related to the display device 210, and the source device may read the DisplayID of the display device, using the second slave address.

Referring to FIG. 7, the DisplayID may include a plurality of data blocks. Specifically, the DisplayID may include the reserved block 710, a display product identification information block 720, a display parameter block 730, a timing information block 740, a display interface 750, and the like.

In some implementations, the plurality of data blocks of the DisplayID may contain block tags TAG unique thereto. Accordingly, the controller of the display device which read the DisplayID in response to a request of the source device may identify a data block on the basis of its block tag, and output information in the corresponding data block, as performance information of the display device.

In some implementations, at least a part of the reserved block 710 may contain the EDID as performance information related to the display device. The part of the reserved block 710 may contain a header 711 consisting of a fixed pattern indicating that the corresponding information is the EDID, display product identification information 712, EDID version information 713 and 714, a display parameter 715, color characteristics 716, and the like. Hereinafter, each information item may be referred to as a section.

In some implementations, the EDID and the DisplayID may contain duplicate information. For example, the display product identification information 712 of the EDID in the reserved block 710 may be identical to information in the display product identification information block 720 of the DisplayID, and the display parameter 715 of the EDID in the reserved block 710 may be identical to information in a display parameter block 730 of the DisplayID. In some implementations, the manufacturer may define the relationship between the EDID information and the DisplayID information, using the mapping information. In other words, the manufacturer may define the value of specific information of the EDID information, identical to DisplayID information, in the mapping information, without describing them in the reserved block 710, such that the controller 215 can obtain the corresponding information of the EDID from the DisplayID.

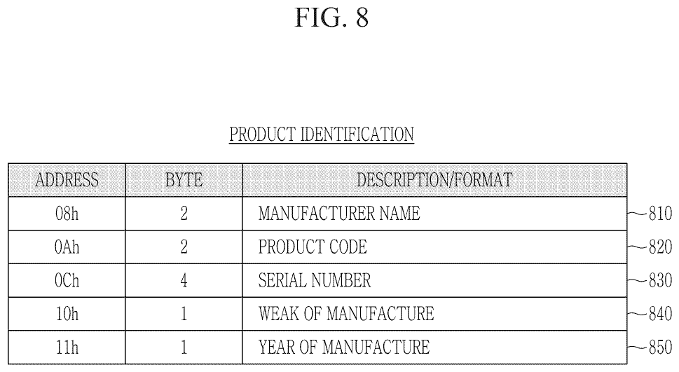

In some implementations, the controller 215 which reads the EDID as performance information of the display device 210 may identify that the EDID starts with the header 711 consisting of the fixed pattern, and read the EDID having a fixed size, as performance information of the display device 210. Referring to FIG. 7, the controller 215 may read the value (VALUE) of the header 711 of the first section, i.e., ‘(00 FF FF FF FF FF FF FF 00)h’, and read the product identification information 712 of the second section. On the basis of the mapping information 216 in the memory 213, the controller 215 may recognize that the value of the product identification information 712 has been defined by the mapping information 216. The controller 215 may read the value ‘01h’ of the EDID version information 713 and the value ‘04h’ of the EDID version (revision) information 714 in the third and fourth sections, and read the display parameter 715 of the fifth section. On the basis of the mapping information 216 in the memory 213, the controller 215 may recognize that the value of the display parameter 715 has been defined by the mapping information 216. The controller 215 may obtain a value of the EDID information on the basis of the mapping information 216, and output the EDID as performance information of the display device 210 to the receiver 211. How the controller 215 obtains a value of the EDID information on the basis of the mapping information 216 will be described below with reference to FIGS. 8 to 13.

FIG. 8 is a drawing illustrating the display product identification information of the EDID.

According to the EDID standard, the display product identification information of the EDID may contain a manufacturer name 810, a product code 820, a serial number 830, manufacture time information 840 and 850, and the like. Also, the address ADDRESS and size BYTE of each display product identification information item of the EDID may be fixed.

In some implementations, the manufacturer may store the mapping information 216, defining the relationship between the DisplayID and the EDID according to a predetermined form, in the memory 213 of the display device 210, such that the controller 215 identifies data blocks containing information identical to the display product identification information of the EDID among the data blocks of the DisplayID and reads information from the corresponding data blocks.

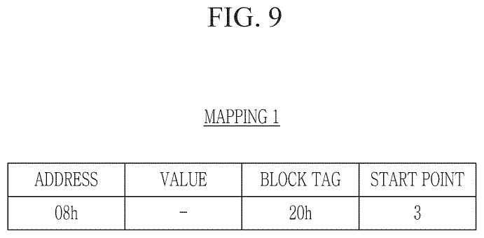

FIG. 9 is a drawing illustrating the mapping information defining the relationship between the DisplayID and the EDID according to some implementations. Specifically, FIG. 9 shows first mapping information defining the relationship between the display product identification information (e.g., reference symbol “712” in FIG. 7) in the EDID and the display product identification information block (e.g., reference symbol “720” in FIG. 7) of the DisplayID.

In some implementations, the mapping information 216 may contain the address (ADDRESS) of EDID information that is the subject of mapping, a value (VALUE) to be input to the corresponding address, the block tag (BLOCK TAG) of a data block of the DisplayID containing information corresponding to the EDID information, and a start point (START POINT) of the DisplayID information corresponding to the EDID information. However, the mapping information is not limited thereto, and the manufacturer may store additional information necessary to define the relationship between the EDID information and the DisplayID information, as mapping information. Also, the manufacturer may omit some of the above-described information.

Referring to FIG. 9, the first mapping information (MAPPING 1) may contain the address ‘08h’ (e.g., reference symbol “810” in FIG. 8) of the display product identification information of the EDID which is the subject of mapping as address information, the block tag ‘20h’ of the display product identification information block of the DisplayID containing the display product identification information, and the start point ‘3’ of the DisplayID information, corresponding to the EDID information, based on the block tag. Here, the start point is a point at which the controller 215 starts reading the DisplayID information as EDID information, and may mean that the display product identification information of the EDID which is the subject of mapping is mapped onto data located 3 bytes later from the block tag of the display product identification information block of the DisplayID.

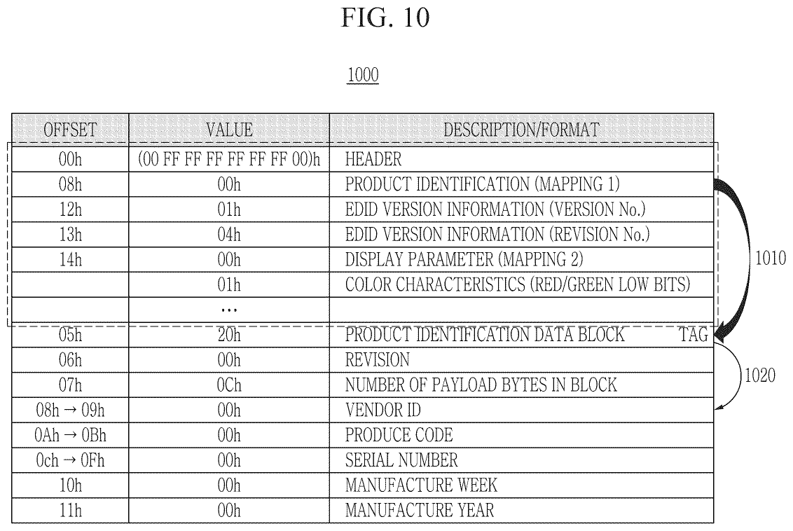

FIG. 10 is a drawing for explaining how the display device provides the EDID on the basis of the mapping information according to some implementations.

In some implementations, the controller 215 may read the EDID in the reserved block of the DisplayID on the basis of a request of the source device 220. The controller 215 may identify that it is the EDID, from the header information consisting of the fixed pattern, and sequentially read the EDID having a fixed size.

In some implementations, the controller 215 may recognize that the display product identification information of the EDID has been defined by the information in the DisplayID, on the basis of the mapping information in the memory 213 of the display device.

Referring to the EDID information of FIG. 8 and the first mapping information of FIG. 9 together, the controller 215 may recognize that the display product identification information of the address ‘08h’ of the EDID is defined by the first mapping information, and detect a data block of the DisplayID, corresponding to the block tag ‘20h’, according to the value of the block tag (BLOCK TAG) of the first mapping information (e.g., reference symbol “1010”). When the controller 215 identifies the data block corresponding to the block tag, the controller 215 can detect the start point of the data corresponding to the display product identification information of the EDID, according to the first mapping information. Specifically, since the first mapping information defines 3 bytes as the start point, the controller 215 may determine the vendor ID (VENDOR ID) located 3 bytes later from the block tag, as the data start point corresponding to the display product identification information of the EDID (e.g., reference symbol “1020”). For example, the vendor ID (VENDOR ID) may correspond to the manufacturer name (e.g., reference symbol “810” in FIG. 8) of the display product identification information of the EDID. According to the EDID standard, the size of the display product identification information of the EDID is fixed to 10 bytes. Accordingly, the controller 215 may read 10 bytes of data from the vendor ID (VENDOR ID), as the display product identification information of the EDID.

Referring to FIG. 8, the display product identification information of the EDID contains the manufacturer name 810, the product code 820, the serial number 830, and the manufacture time information 840 and 850 in the order named. In FIG. 10, the display product identification information block of the DisplayID contains the vendor ID (VENDOR ID), the produce code (PRODUCE CODE), the serial number (SERIAL NUMBER), and the manufacture time information (MANUFACTURE WEEK and MANUFACTURE YEAR) in the order named. Accordingly, the corresponding information items of the DisplayID may correspond to the corresponding information items of the EDID over the size of the display product identification information of the EDID.

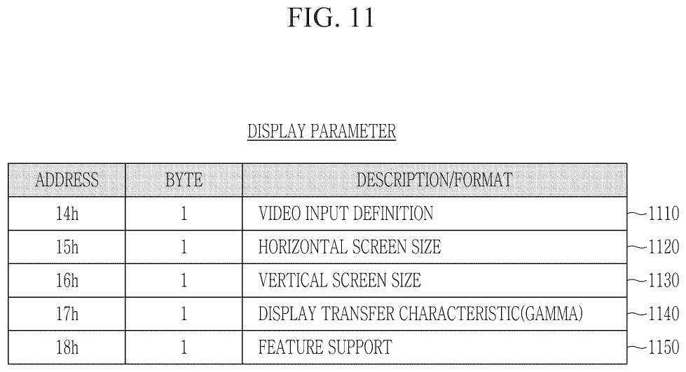

FIG. 11 is a drawing for explaining the display parameter information of the EDID.

According to the EDID standard, the display parameter information of the EDID may contain whether the display device has received any analog or digital input or not (e.g., reference symbol “1110”), the maximum horizontal size (e.g., reference symbol “1120”) and maximum vertical size (e.g., reference symbol “1130”) of the display, a gamma transfer characteristic (e.g., reference symbol “1140”), a power management function (e.g., reference symbol “1150”), etc. Also, the address (ADDRESS) and size (BYTE) of each of the display parameter information of the EDID may be fixed.

In some implementations, the manufacturer may generate and store the mapping information defining the relationship between the DisplayID and the EDID according to the predetermined form, such that the controller 215 identifies a data block containing information identical to the display parameter information of the EDID, among the data blocks of the DisplayID, and reads information in the corresponding data block.

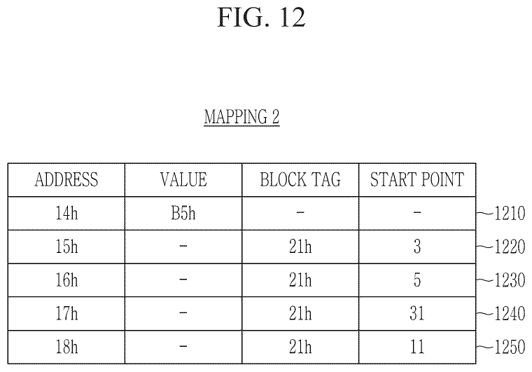

FIG. 12 is a drawing illustrating mapping information defining the relationship between the DisplayID and the EDID according to some implementations. Specifically, FIG. 12 is a drawing for explaining a mapping method when second mapping information defines the relationship between the display parameter information (e.g., reference symbol “715” in FIG. 7) in the EDID and the display parameter (e.g., reference symbol “730” in FIG. 7) of the DisplayID, and the information of the DisplayID corresponding to the EDID information is not consecutive.

Referring to the first row 1210 of the second mapping information (MAPPING 2), the second mapping information (MAPPING 2) may contain the address ‘14h’ (e.g., reference symbol “1110” in FIG. 11) of the display parameter information of the EDID which is the subject of mapping, and the value ‘B5h’ of data to be input to the corresponding address. On the basis of the second mapping information (MAPPING 2), the controller 215 may read a value corresponding to the address ‘14h’ of the display parameter information of the EDID, as the input value ‘B5h’.

Referring to the second row 1220 of the second mapping information (MAPPING 2), the second mapping information (MAPPING 2) may contain the address ‘15h’ (e.g., reference symbol “1120” in FIG. 11) of the display parameter information of the EDID which is the subject of mapping, the block tag ‘21h’ of the display parameter block of the DisplayID containing display parameter information, and the start point ‘3’ of the DisplayID information, corresponding to the EDID information, based on the block tag.

In the above-mentioned way, the other rows of the second mapping information (MAPPING 2) may also contain the addresses ‘16h’, ‘17h’, and ‘18h’ (e.g., reference symbols “1130,” “1140,” and “1150” in FIG. 11) of the display parameter information of the EDID which are the subjects of mapping, the block tag ‘21h’ of the display parameter block of the DisplayID containing the display parameter information, and the start points ‘5’, ‘31’, and ‘11’ of the DisplayID information, corresponding to the EDID information, based on the block tag.

As described above, when the information of the DisplayID corresponding to the EDID information is not consecutive, it is possible to define the relationship between the DisplayID and the EDID by making the EDID information items to the DisplayID information items, respectively.

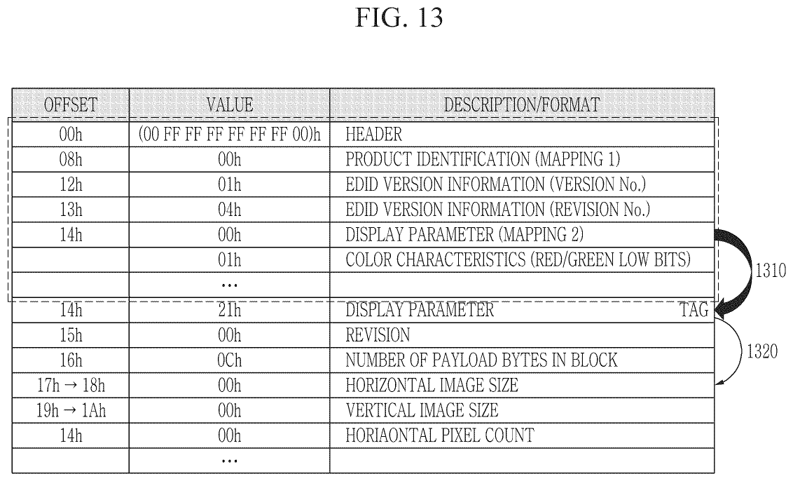

FIG. 13 is a drawing for explaining how the display device provides the EDID on the basis of the mapping information according to some implementations.

In some implementations, on the basis of the mapping information 216 in the memory 213 of the display device 210, the controller 215 may recognize that the display parameter information of the EDID has been defined by the information in the DisplayID.

Referring to the EDID information of FIG. 11 and the second mapping information of FIG. 12 together, the controller 215 may recognize that the display parameter information at the address ‘14h’ of the EDID is defined by the second mapping information, and read a value corresponding to the address ‘14h’ of the EDID, as ‘B5h’, according to the second mapping information.

In some implementations, the controller 215 may recognize that the display parameter information at the address ‘15h’ of the EDID is defined by the second mapping information, and detect a data block of the DisplayID corresponding to the block tag ‘21h’, according to the block tag values of the second mapping information (e.g., reference symbol “1310”). When the controller 215 identifies the data block corresponding to the block tag, it can detect the start point of the data corresponding to the display parameter information of the EDID, according to the second mapping information. In other words, the controller 215 may determine the horizontal image size (HORIZONTAL IMAGE SIZE) located 3 bytes after the block tag, as the start point, on the basis of the second mapping information (e.g., reference symbol “1320”). For example, the horizontal image size (HORIZONTAL IMAGE SIZE) may correspond to the horizontal screen size (e.g., reference symbol “1120” in FIG. 11) of the display parameter information of the EDID. According to the EDID standard, the size of the horizontal screen size information of the display parameters of the EDID is fixed to 1 byte. Accordingly, the controller 215 may read 1 byte of data from the horizontal image size (HORIZONTAL IMAGE SIZE) information, as the horizontal screen size information of the EDID. In the above-mentioned way, the controller 215 may obtain the display parameter information of the EDID.

As described above, the manufacturer may store the EDID in the reserved block of the DisplayID. Also, the manufacturer may store the EDID by mapping duplicate information between the EDID information and the DisplayID information. According to the EDID storing method according to some implementations, the display device can store the DisplayID and the EDID together while maintaining the size of the DisplayID, and there is an advantage that it is possible to improve the compatibility between the source device and the display device.

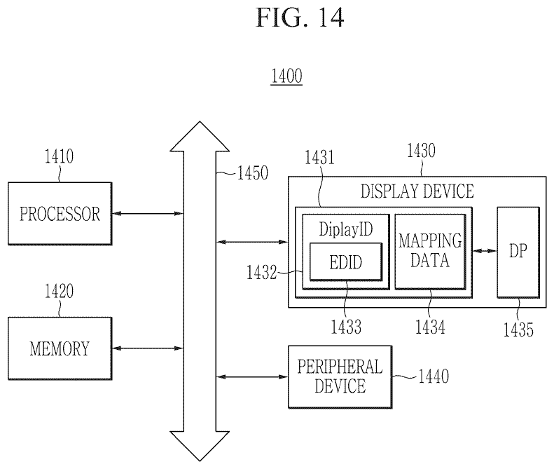

FIG. 14 is a drawing for explaining a display system according to some implementations.

Referring to FIG. 14, a display system 1400 according to some implementations includes a processor 1410, a memory 1420, a display device 1430, and a peripheral device 1440 which are electrically connected to a system bus 1450.

The processor 1410 may control data input and output of the memory 1420, the display device 1430, and the peripheral device 1440, and perform image processing on image data which are transmitted between the corresponding devices.

The memory 1420 may include volatile memories such as dynamic random access memories (DRAMs) and/or nonvolatile memories such as flash memories. The memory 1420 may be configured with DRAMs, phase-change random access memories (PRAMs), magnetic random access memories (MRAMs), resistive random access memories (ReRAMs), ferroelectric random access memories (FRAMs), NOR flash memories, NAND flash memories, fusion flash memories (e.g., a memory in which static random access memory (SRAM) buffers, NAND flash memories, and NOR interface logics are combined), etc. The memory 1420 may store image data obtained from the peripheral device 1440, or store image signals processed by the processor 1410.

The display device 1430 includes a memory 1431 for storing performance information of the display device 1430, and a display panel 1435 for displaying images according to the performance of the display device 1430. In some implementations, the display device 1430 may contain DisplayID 1432 and EDID 1433 as performance information, and contain mapping information 1434 defining the relationship between specific information of the DisplayID 1432 and specific information of the EDID 1433. The DisplayID 1432 and the EDID 1433 may be the DisplayID and the EDID described with reference to FIGS. 7 to 13.

The peripheral device 1440 may be a device for converting videos, still images, or the like into electrical signals, such as a camera, a scanner, a webcam, or the like. Image data obtained through the peripheral device 1440 may be stored in the memory 1420, or may be displayed on the panel 1435 in real time.

The display system 1400 may be provided in a mobile electronic product such as a smart phone but is not limited thereto, and may be provided in various types of electronic products which display images.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination

The implementations have been disclosed in the drawings and specification as above. Specific terms used in this specification have been used to describe the implementations; however, they have been used for the purpose of describing the technical idea of the present disclosure, and have not been used to limit the meanings and the scope of the present disclosure described in the claims. Accordingly, those skilled in the art will understand that various modifications and other equivalent implementations are possible therefrom. Therefore, the true technical scope of protection of the present disclosure should be defined by the technical scope of the appended claims.

What is claimed is:

1. A display device comprising:
a receiver configured to receive, from an external device, a first request signal requesting first performance information as performance information of the display device;
a memory configured to store second performance information, the second performance information comprising a first data block and a second data block, wherein the first data block comprises first data, wherein the first data is a header that comprises a fixed pattern indicating the first performance information, and wherein the second data block comprises second data, wherein the second data comprises one or more block tags that identify one or more data blocks; and
a controller configured to output, to the receiver and in response to the first request signal, the first performance information obtained from the first data, wherein the first performance information has a predetermined size, and wherein the receiver is configured to output the first performance information to the external device.

2. The display device of claim 1, wherein:
the controller is configured to identify the first performance information based on the first data, and the controller is configured to sequentially read the first performance information from the first data, the first performance information having a predetermined length.

3. The display device of claim 2, wherein the memory is configured to store a command instructing the controller to read second information in the second data block,
wherein the second information is mapped onto first information among a plurality of pieces of information of the first performance information, and
wherein the controller is configured to read the second information as the first information based on the command.

4. The display device of claim 2, wherein the memory is configured to store mapping information,
wherein the mapping information indicates a mapping of first information among a plurality of pieces of information of the first performance information onto second information in the second data block, and
wherein the controller is configured to read the second information as the first information based on the mapping information.

5. The display device of claim 4, wherein the mapping information comprises:
third information identifying the first information;
the second data; and
fourth information identifying the second information.

6. The display device of claim 1, wherein:
the receiver is configured to further receive, from the external device, a second request signal requesting the second performance information as performance information of the display device.

7. The display device of claim 6, wherein:
the controller is configured to identify the second data block based on the second data, and the controller is configured to output information of the second data block as the second performance information to the receiver.

8. The display device of claim 1, wherein:
the first performance information includes extended display identification data, and the second performance information includes display identification data.

9. The display device of claim 1, further comprising a display configured to:
display a first content based on the first performance information, the first content having a first resolution; and
display a second content based on the second performance information, the second content having a second resolution different from the first resolution.

10. An operation method of a display device, the method comprising:
receiving a first request signal requesting first performance information of the display device;
reading the first performance information from second performance information based on the first request signal, the second performance information comprising the first performance information;
obtaining first information of the first performance information based on second information read from the second performance information; and
outputting the first performance information.

11. The operation method of the display device according to claim 10, wherein reading the first performance information from the second performance information comprises:
identifying the first performance information based on first data having a fixed pattern; and
sequentially reading data having a predetermined size from the first data.

12. The operation method of the display device according to claim 10, wherein obtaining first information of the first performance information based on second information read from the second performance information comprises:
identifying the first information based on mapping information;
detecting a data block based on the mapping information, the data block comprising the second information;
identifying the second information in the data block based on the mapping information; and
mapping the data of the second information onto the first information.

13. The operation method of the display device according to claim 10, wherein:
the first performance information includes extended display identification data, and the second performance information includes display identification data.

14. The operation method of the display device according to claim 10, further comprising:
receiving a second request signal requesting second performance information of the display device;
reading the second performance information based on the second request signal; and
outputting the second performance information.

15. An electronic system comprising:
a first source device configured to output a first request signal requesting first performance information, the first performance information comprising performance information of a display device;
a second source device configured to output a second request signal requesting second performance information, the second performance information comprising performance information of the display device; and
a display device configured to output, based on the first request signal, at least a subset of the second performance information as the first performance information to the first source device, and configured to output, based on the second request signal, the second performance information to the second source device.

16. The electronic system of claim 15, wherein the first performance information comprises first data having a fixed pattern identifying the first performance information, and
wherein the display device is configured to output, based on the first request signal, the first performance information having a predetermined size from the first data.

17. The electronic system of claim 15, wherein:
the first source device is configured to read the first performance information based on a first slave address, and the second source device is configured to read the second performance information based on a second slave address different from the first slave address.

18. The electronic system of claim 17, wherein:
the first slave address is A0h and A1h, and the second slave address is A4h and A5h.

19. The electronic system of claim 15, wherein:
the second performance information includes a plurality of areas, and a first area of the plurality of areas comprises the first performance information on a first resolution, and a second area of the plurality of areas comprises information on a second resolution different from the first resolution.

20. The electronic system of claim 19, wherein the first source device is configured to output a first content signal with the first resolution based on the first performance information,
wherein the second source device is configured to output a second content signal with the second resolution based on the second performance information, and
wherein the second resolution is higher than the first resolution.
